(19) United States
(12) Patent Application Publication
(10) Pub. No.: US 2007/0147697 A1
(43) Pub. Date: Jun. 28, 2007

(54) Method for removing noise in image and system thereof

(76) Inventors: Seong Won Lee, Kyunggi-do (KR); Maik Vivek, Seoul (KR); Joon Ki Paik, Seoul (KR); Ji Hoon Jang, Kyunggi-do (KR)

Correspondence Address: LADAS & PARRY LLP, 224 SOUTH MICHIGAN AVENUE, SUITE 1600, CHICAGO, IL, 60604, US

(21) Appl. No.: 10/579,087

(22) PCT Filed: Aug. 19, 2005
(86) PCT No.: PCT/KR05/02742

§ 371 Date: May 12, 2006

(30) Foreign Application Priority Data
Aug. 26, 2004 (KR) 10-2004-0067615

(51) Int. Cl. G06K 9/40

(52) U.S. Cl. 382/260

(57) ABSTRACT

Disclosed are a method for removing noise in an image, including the steps of: dividing image data contained in the image into predetermined unit areas; calculating each threshold corresponding to the unit area by using values of pixels contained in the unit area; detecting whether a first pixel containing impulsive noise exists in the unit area by using the calculated threshold; applying a median filter to the first pixel in the case the first pixel is detected; identifying a second pixel adjacent to the first pixel in the case the median filter is applied to the first pixel; and applying a mean-variance filter to the second pixel, and a system thereof.

### TECHNICAL FIELD

The present invention relates to a method for removing noise in an image and a system thereof. More particularly, the present invention relates to a method for removing noise which can remove noise without damaging edge or detailed information, thereby maintaining the resolution of the image, and a system thereof.

### BACKGROUND ART

Today, owing to the development of video technology, video multimedia is being developed in which high performance cameras, digital cameras, CCTVs, video capture systems, and the like can take a picture and store various images. The most important thing of video multimedia as above is to precisely restore the image of a photographed subject. Particularly, noise contained in the image may deteriorate its quality and also decrease its ability to be compressed effectively. Accordingly, the most important task in restoring the image is to precisely store the image by removing noise before storage.

However, in case of applying a spatial filter or temporal filter when removing noise contained in an image, the noise may be removed, but smearing or blur occurs. Thus, the image resolution itself is deteriorated. Particularly, in the case a picture is taken in a poor environment where light is insufficient, an even greater amount of noise is contained in the image and thus, the problem as above gets more serious.

### DISCLOSURE OF INVENTION

Technical Goals

An object of the present invention is to provide a method for removing noise in an image, which can effectively remove impulsive or Poisson noise in the process of performing spatial filtering on the image and preserve the edge or detailed information of the image, thereby maintaining its resolution, and a system thereof.

Technical Solutions

To achieve the above goal and solve the problems in the prior art, according to an aspect of the present invention, there is provided a method for removing noise in an image, the method including the steps of: dividing image data contained in the image into predetermined unit areas; calculating each threshold corresponding to the unit area by using values of pixels contained in the unit area; detecting whether a first pixel containing impulsive noise exists in the unit area by using the calculated threshold; applying a median filter to the first pixel in the case the first pixel is detected; identifying a second pixel adjacent to the first pixel in the case the median filter is applied to the first pixel; and applying a mean-variance filter to the second pixel.

Also, according to another aspect of the present invention, there is provided a system for removing noise in an image, the system including: a threshold calculation unit dividing image data contained in the image into a predetermined unit area and calculating each threshold corresponding to the unit area by using values of pixels contained in the unit area; a first filter detecting whether a first pixel containing impulsive noise exists in the unit area by using the calculated threshold and applying a median filter to the first pixel in the case the first pixel is detected; and a second filter identifying a second pixel adjacent to the first pixel and applying a mean-variance filter to the second pixel.

### BRIEF DESCRIPTION OF DRAWINGS

FIG. 1 is a block diagram illustrating a configuration of a noise removing system according to an embodiment of the present invention;

FIG. 2 is a flowchart illustrating procedures of removing noise via the noise removing system according to an embodiment of the present invention;

FIG. 3 is a view illustrating results of removing noise in a unit area containing edge and detailed information and in a unit area not containing edge and detailed information according to an embodiment of the present invention;

FIG. 4 is a view illustrating the noise removing system according to the present invention is used as a prefilter;

FIG. 5 is a block diagram illustrating an image processing system employing the noise removing system according to an embodiment of the present invention;

FIG. 6 is a flowchart illustrating an image processing method according to another embodiment of the present invention;

FIG. 7 is a view illustrating the entire image divided into a high light region and a low light region by a dividing filter, in an embodiment of the present invention;

FIG. 8 is a view for explaining impulsive noise and Poisson noise;

FIG. 9 is a view for explaining a false motion pixel;

FIG. 10 is a view schematically illustrating a process of removing impulsive noise, Poisson noise, and false color noise from image data contained in at least one segment that is divided as a low light region, in an embodiment of the present invention;

FIG. 11 is a view comparing image processing results of a conventional art with results of image processing method and system according to the present invention;

FIG. 12 is a view of the relationship between PSNR (Peak Signal to Noise Ratio) and compression ratio of a resulting image file processed with the image processing method and system according to an embodiment of the present invention compared with a resulting image file processed with a conventional art; and

FIG. 13 is an internal block diagram of a general-purpose computer system which may be employed in implementing the image processing method and system according to the present invention.

### BEST MODE FOR CARRYING OUT THE INVENTION

Hereinafter, the present invention will be described in detail with reference to the accompanying drawings.

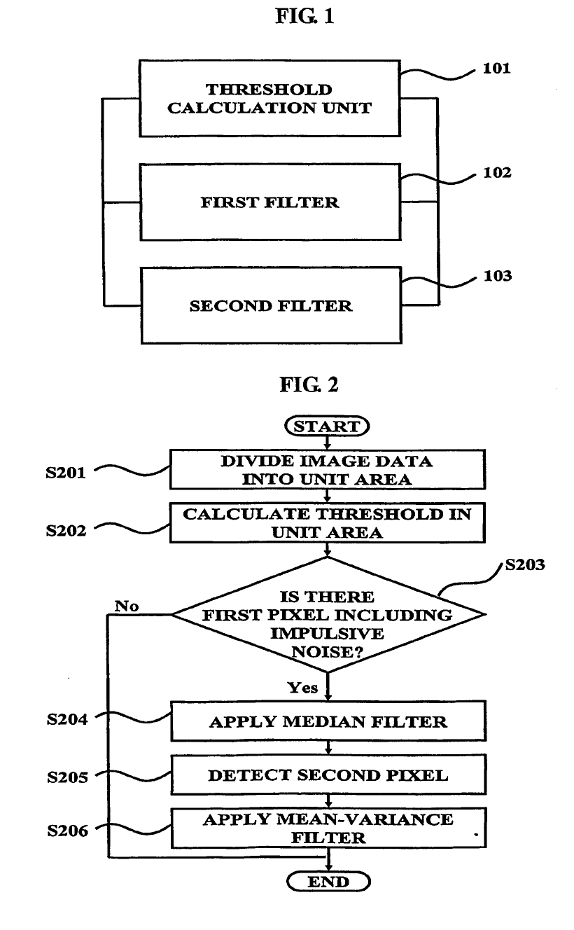

FIG. 1 is a block diagram illustrating a configuration of a noise removing system according to an embodiment of the present invention. Referring to FIG. 1, the noise removing system according to the present invention may include a threshold calculation unit 101, a first filter 102, and a second filter 103.

The threshold calculation unit 101 divides image data of an image into predetermined unit areas and calculates each threshold corresponding to a unit area by using values of pixels contained in the unit area;

The first filter 102 detects whether a first pixel containing impulsive noise exists in the unit area by using the calculated threshold and applies a median filter to the first pixel in the case the first pixel is detected.

The second filter 103 identifies a second pixel adjacent to the first pixel in the case the median filter is applied to the first pixel, and applies a mean-variance filter to the second pixel.

Hereinafter, operations of each component of the noise removing system will be described in further detail with reference to FIG. 2. FIG. 2 is a flowchart illustrating procedures of removing noise via the noise removing system according to the present invention.

In step S201, the threshold calculation unit 101 of the noise removing system divides image data contained in an image into predetermined unit areas.

In step S202, the threshold calculation unit 101 calculates the threshold of each unit area by using values of pixels contained in the unit area. The threshold is used to determine whether impulsive noise exists in the unit area. The threshold may be calculated as equation 1:
Threshold=α+log₂(xₘ) [Equation 1]

At this time, said α is the minimum threshold to detect a pixel containing impulsive noise and said xₘ is the mean of values of the pixels contained in the unit area. As above, threshold is dynamically calculated for each unit area. Thus, the noise removing system according to the present embodiment may detect impulsive noise more accurately.

In step S203, the first filter 102 determines that a predetermined pixel contains impulsive noise, if a value of the pixel contained in a predetermined unit area is higher than the threshold calculated by equation 1 for the unit area. Also, the first filter 102 determines that the pixel does not contain impulsive noise, if the value is lower than the threshold. Hereinafter, the pixel containing impulsive noise indicates a “first pixel”.

In step S204, the first filter 102 applies the median filter to the first pixel if a pixel is detected as a first pixel, and replaces a value of the first pixel with a median value, thereby removing impulsive noise. The first filter 102 may employ the median filter such as equation 2:
TJ″=Median(xᵥ^{w}) [Equation 2]

At this time, said W is a unit area and (i, j) is coordinates of the first pixel on the entire image. Y is a changed value of the first pixel. Namely, impulsive noise may be removed by changing the first pixel value into Y.

First, if the first pixel is detected, the second filter 103 applies the mean-variance filter to pixels around the first pixel. Namely, the first filter 102 interacts with the second filter 103.

Generally, in many cases, Poisson noise occurs in pixels around a pixel containing impulsive nose. Thus, in the present embodiment, the first filter 102 applies the mean-variance filter to the pixels around the pixel containing impulsive noise, thereby removing both the impulsive noise and Poisson noise simultaneously. A method of removing noise by approximating Poisson noise distribution to Gaussian distribution having the mean and the variance may be used to remove Poisson noise.

In step S205, the second filter 103 detects second pixels which are the local neighborhood adjacent to the first pixel. In step S206, the second filter 103 applies the mean-variance filter to the second pixels, thereby correcting values of pixels around a pixel containing impulsive noise (second pixel: LND, Local Neighborhood). For example, the mean-variance filter may be applied to pixels, which are 8 pixels neighboring the first pixel in the area of 3×3 pixels.

The second filter 103 may employ the mean-variance filter like equation 3:

$$LND ( i , j ) = \frac{{σ}_{k}^{2} ( i , j ) k ( i , j ) + {\overline{k}}^{2} ( i , j )}{{σ}_{k}^{2} ( i , j ) + \overline{k} ( i , j )} \qquad [ Equation 3 ]$$

At this time, said σₖ(i, j) and k̅<i, />indicate the variance and the mean of second pixels adjacent to k(i, j), which is the coordinates of the first pixel, in the area formed of a predetermined size.

In the area of a predetermined size where there is no change, it is calculated as σk′\i>j)=0. Accordingly, equation 3 may be represented as below:
LND(i,j)= k̅(i,j) [Equation 4]
Equation 4 indicates that a pixel value of the local neighborhood is approximate to the mean in the area and that Poisson noise has been effectively removed.

In contrast to this, in the area where image data contains edge or detailed information, the mean σk(i, j″) takes on a higher value. Accordingly, equation 3 may be approximated as below:
LNDQJ)=kQJ) [Equation 5]

As shown in equation 5, a second pixel value is unchanged in the area which contains edge or detailed information, that is, in the area where there is a lot of change. Accordingly, the edge or detailed information is preserved.

By means of the configuration as described above, the noise removing system according to the present invention applies the median filter to a first pixel containing impulsive noise to remove the same, and applies the mean-variance filter to second pixels which are the local neighborhood of the first pixel, to remove Poisson noise.

Only in case the first pixel is detected, the second filter 103 applies the mean-variance filter to second pixels around the first pixel. Thus, according to the present invention, consequently, the median filter to remove impulsive noise interacts with the mean-variance filter to remove Poisson noise.

Particularly, the mean-variance filter, according to the present invention, takes values of second pixels adjacent to the first pixel with the mean only in the area not containing edge or detailed information. Thus, the edge or detailed information may be preserved.

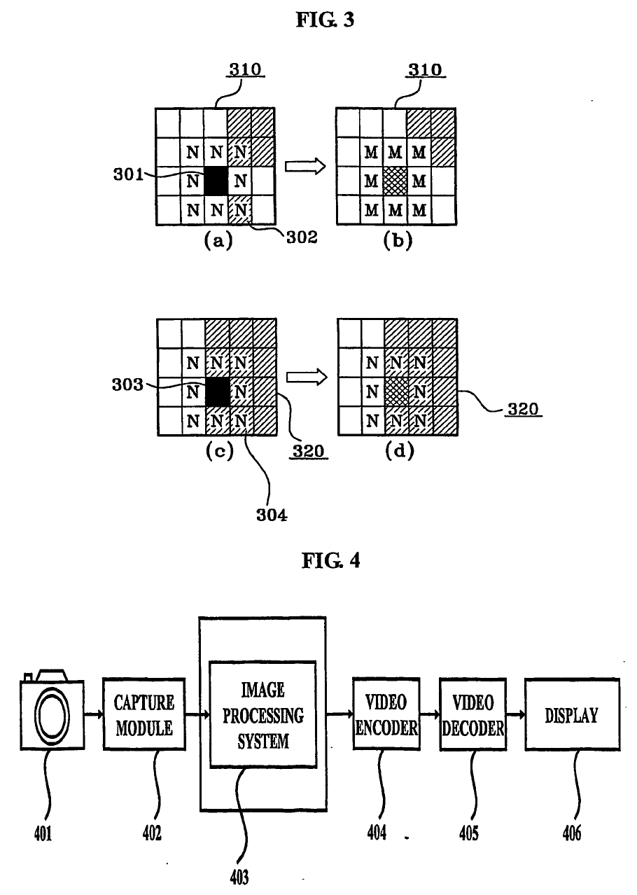

FIG. 3 is a view illustrating noise processing results in a unit area containing edge and detailed information and in a unit area not containing edge and detailed information according to an embodiment of the present invention.

Referring to FIG. 3, the process of removing noise in a unit area 310 not containing edge and detailed information and the process of removing noise in a unit area 320 containing edge and detailed information are performed separately. Thus, the noise removing system preserves the edge and detailed information of an image, while removing Poisson noise. Hereinafter, the noise removing system will be described in detail. (a) of FIG. 3 is the original unit area 310 and (b) of FIG. 3 is the unit area 310 after the median filter and the mean-variance filter are applied. Also, (c) of FIG. 3 is the original unit area 320 and (d) of FIG. 3 is the unit area 320 after the median filter and the mean-variance filter are applied.

First, the process of removing noise in the unit area 310 not containing edge and detailed information in an inputted image will be described. Namely, the case that a first pixel 301 containing impulsive noise occurs in the unit area 310 will be described. The first filter 102 of the noise removing system identifies the first pixel 301 in the unit area 310 by using the threshold calculated by equation 1 and corrects the value of the first pixel 301 as the median value by using the median filter as above.

The second filter 103 applies the mean-variance filter to second pixels 302 which are pixels adjacent to the first pixel 301 and replaces a value of the second pixel 302 (N) with the mean (M). Namely, since each value of the second pixels 302 changes only a little in the unit area 310 which does not contain edge or detailed information, the variance of the second pixels becomes smaller. Thus, as shown in equation 4, the value of the second pixels (N) is corrected as the mean of the second pixels (M).

Consequently, impulsive noise and Poisson noise contained in the unit area 310 are effectively removed.

Next, the process of removing noise in the unit area 320 containing edge and detailed information in the inputted image will be described. A first pixel 303 containing impulsive noise in the unit area 320 is corrected as a median value by the median filter of the first filter 102, as above. A second pixel 304 which is a pixel adjacent to the first pixel 303 in the unit area 320 is also corrected by the mean-variance filter of the second filter 103. At this time, the second pixel 304 of the unit area 320 belongs to an area where a great change occurs because of edge or detailed information. Thus, the variance of the second pixels 304 becomes large and the corrected value like equation 5 is unchanged from the original value of the second pixel (N). Consequently, in an area which contains many image features such as edge or detailed information contained in an image, the original pixel value is unchanged whereby edge and detailed information maintain their resolutions while removing impulsive noise.

Also, hereinafter, an image processing system used in the noise removing system according to the present invention will be described as an illustrative example. Particularly, the image processing system according to the present embodiment may effectively remove impulsive noise or Poisson noise in an image. The image was photographed in a low light environment and the image source itself is not clear.

FIG. 4 is a view illustrating that the image processing system is used as a prefilter. An image photographed with a camera 401 is captured in a capture module 402, and an image processing system 403 including the noise removing system according to the present invention prefilters the image, so as to remove noise. This is to obtain a good quality image and improve the compression effectiveness before the image is encoded to be digitalized or compressed by a video encoder 404.

The image encoded by the video encoder 404 may be stored in a storage space of the system or transmitted to a remote system via a network. The image stored in the storage space or the image transmitted to the remote system or the image transmitted to the remote system to be stored therein may be decoded by a video decoder 405 and displayed on a predetermined display 406. In this case, FIG. 4 illustrates that the image processing system 403 according to the present invention is configured as a prefilter, but it is only an example. The present invention may be widely used to effectively remove noise in a photographed image and improve its resolution.

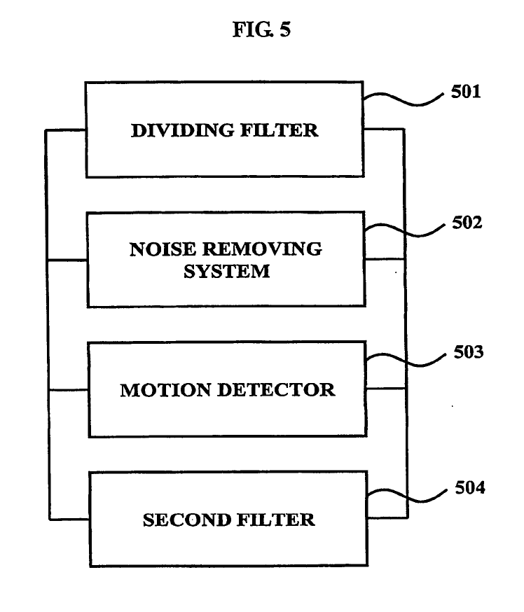

Hereinafter, the operations of the image processing systems 403 according to the present embodiment will be described in further detail with reference to FIG. 5. FIG. 5 is a block diagram illustrating the image processing system according to the present invention.

The image processing system includes a dividing filter 501, a noise removing system 502, a motion detector 503, and a second filter 504.

The dividing filter 501 divides an image sequentially inputted for each frame into a segment comprising the predetermined number of pixels. Also, the dividing filter 501 divides each segment into a low light region or a high light region by using the lightness of image data contained in said each segment. Also, in contrast, brightness or a focus measure of each pixel may be used to determine the lightness. In the present embodiment, “image data belonging to an area containing a segment divided into the low light region” may be referenced as “image data”. Also, to distinguish image data belonging to the low light region or the high light region, an image referenced as “the entire image” contains both the low light region and the high light region, which is an image inputted into the noise removing system. Accordingly, the image data may be just a part of the entire image or the entire image itself.

The noise removing system 502 removes impulsive noise from image data contained in at least one segment which is divided into the low light region.

The motion detector 503 detects a motion pixel in the image data.

The second filter 504 detects false color noise and removes the detected false color noise from the image data.

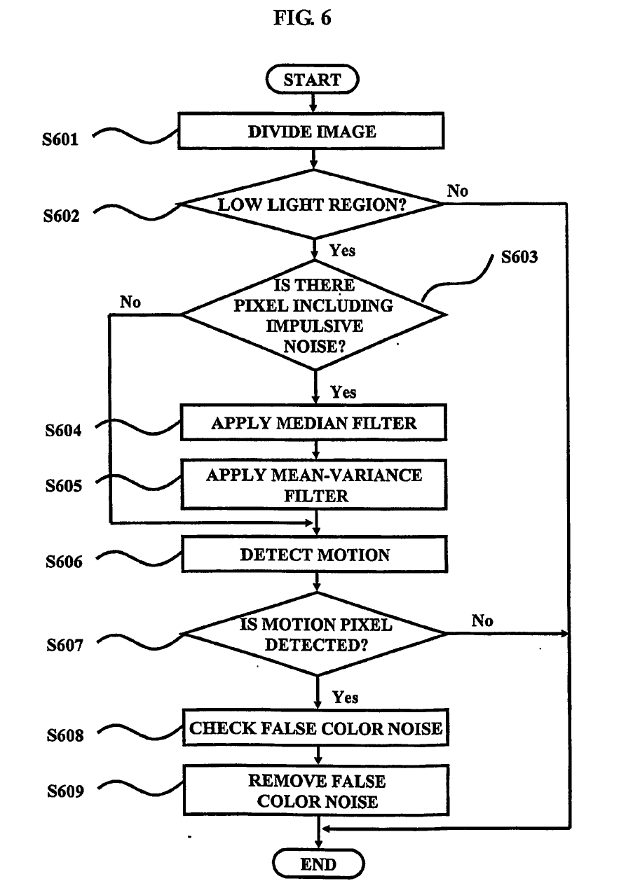

Hereinafter, the operations of each component of the image processing system, as illustrated in FIG. 5, will be in detail described with reference to FIG. 6.

In step S601, when an image is sequentially inputted for each frame, the dividing filter 501 divides the image into a segment comprising the predetermined number of pixels. For example, an image photographed with the camera 401 may be inputted into the image processing system with a frame rate of 15 [frame/sec].

The size of the segment the dividing filter 501 divides the entire image into may be determined by considering the processing effectiveness and preciseness. For example, the dividing filter 501 may divide the entire image into segments having the size of 4×4 pixels.

In step S602, the dividing filter 501 recognize the lightness of image data contained in each segment, and determines it as a high light region where the lightness exceeds threshold or determines it as a low light region where the lightness is less than the threshold.

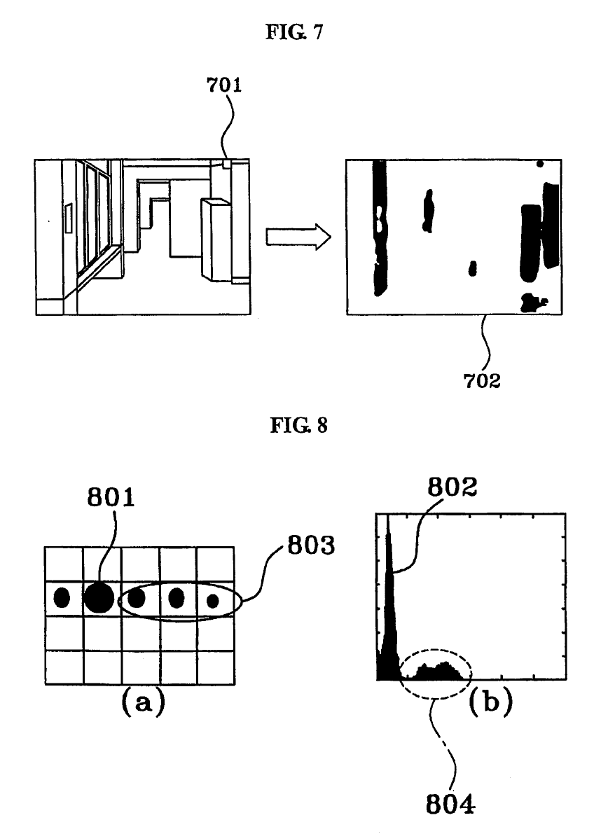

FIG. 7 is a view illustrating the entire image divided into the high light region and the low light region by the dividing filter 501. Drawing symbol 701 indicates the entire image, and drawing symbol 702 indicates the image divided into the high light region and the low light region. At this time, in the drawing symbol 702, the white colored part is for the low light region and the black colored part is for the high light region.

At this time, the image processing system may omit image processing for image data contained in a segment divided into the high light region and perform image processing, such as removing noise, only for image data contained in the segment divided into the low light region, thereby improving the effectiveness of calculation for processing the entire image. Namely, according to the present invention, the region where the image processing system has to perform image processing decreases. Thus, time can be saved in calculations. Also, it is possible to guarantee that noise can be sufficiently removed by performing image processing only for image data of the dark region containing a lot of noise. Particularly, according to the present embodiment, image processing may be omitted for image data in the high light region. Thus, it is possible to prevent blurriness caused by a noise-filter in a high-quality image contained in the high light region.

In step S603, the noise removing system 502 separates image data included into the segment which is divided into the low light region, into at least one unit area, and detects whether a pixel containing impulsive noise, that is, a corrupted pixel, exists in each unit area. In the present embodiment, the pixel containing impulsive noise is a “first pixel”.

FIG. 8 is a view illustrating impulsive noise or Poisson noise as described later. Drawing symbol 801 in (a) of FIG. 8 indicates a first pixel containing impulsive noise. Also, (b) of FIG. 8 is a view illustrating each value of pixels belonging to a line containing the first pixel 801. Drawing symbol 802 indicates that a value of the first pixel is abnormally large, in other words, that impulsive noise has occurred.

The noise removing system 502 detects the first pixel in a predetermined unit area by using a threshold like equation 1.

As described above, the noise removing system 502 applies the median filter like equation 2 when a pixel is detected as a first pixel, thereby replacing the value of the first pixel with a median value. In this manner, impulsive noise is removed.

In equation 2, W is a unit area and (i,j) is the coordinates of the first pixel in the entire image. Also, Y is a changed value of the first pixel, in other words, impulsive noise is removed.

However, in many cases, pixels neighboring the pixel containing impulsive noise have Poisson noise as described in (a) of FIG. 8. As shown by drawing symbol 804 in (b) of FIG. 8, Poisson noise occurs in a similar distribution to a value located in a tail of Gaussian distribution.

As described above, in step S605, the noise removing system 502 detects second pixels adjacent to the first pixel to remove the Poisson noise, and applies the mean-variance filter like equation 3 to the second pixels, thereby correcting values of second pixels adjacent to the first pixel containing impulsive noise.

According to the configuration as above, the noise removing system 502 of the present invention removes impulsive noise by applying the median filter to the first pixel containing the impulsive noise. Also, the noise removing system 502 removes Poisson noise by applying the mean-variance filter to second pixels that are the local neighborhood of the first pixel.

The noise removing system 502 applies the mean-variance filter to the second pixel adjacent to the first pixel, only in the case the first pixel is detected. Consequently, according to the present invention, the median filter to remove impulsive noise interacts with the mean-variance filter to remove Poisson noise.

In step S606, the motion detector 503 compares the image data for each frame, thereby detecting a motion pixel. At this time, the image data is consecutively inputted per frame unit. In the present embodiment, image data corresponding to an arbitrary frame is “first image data” and image data corresponding to a frame inputted right after said arbitrary frame is “second image data”.

The step S606 of detecting a motion pixel is performed before removing false color noise in image data. Filtering for removing the false color noise may cause motion blur. Thus, it is preferable that the false color noise is applied only in the static area where there is no motion pixel.

Unlike impulsive noise or Gaussian noise, in case of false color noise, it is difficult to detect false color noise with a method of comparing the value of a corresponding pixel or with a method of comparing the value of the local neighborhood in a frame of the image. Thus, the false color noise has to be detected by comparing each frame in chronological order. Accordingly, a frame prior to a current frame should be stored in a predetermined memory means for storing temporarily, so as to compare frames in chronological order, that is, consecutive frames.

Accordingly, in the case a corresponding pixel value changes in an image which is consecutively inputted, it may be a normal motion pixel or undesirable false color noise. Once a motion pixel is detected, the rest may be treated as the false color noise.

In step S607, the motion detector 503 detects a motion pixel by comparing pixels corresponding to each other for each predetermined unit area in a consecutively inputted frame. The size of the unit area for the motion detection may be set differentially from that of the aforementioned unit area for removing impulsive noise or Poisson noise. Also, the motion detector 503 compares the image of a previous frame and that of a current frame. Thus, the motion detector 503 has to temporarily store the image of the previous frame.

The motion detector 503 according to the present embodiment may compare pixels in an identical unit area on consecutive and different frames by using a threshold, as shown in equation 6.

$$SAD ( m , n ) = {\sum }_{k} {\sum }_{l} \vert x ( k , l , t ) - x ( k , l , t - 1 ) \vert , \\ k , l ∈ {A}_{ mn} \qquad [ Equation 6 ]$$

SAD (sum absolute difference) indicates the threshold which is determined for each unit area (blocks m and n) for the motion detection. x(k, I, t−1) indicates a pixel value of a pixel in the previous frame and x(k, I, t) indicates a pixel value of a pixel corresponding to the pixel in the current frame. Also, Aₘₙ indicates a unit area to which image data of the frame belongs. Accordingly, according to equation 6, pixels having coordinates (Jc, F) are contained in the unit area.

If a motion pixel is detected from pixels whose pixel values change as time passes, that is, in consecutive frames, the second filter 504 applies temporal filtering to the static area, which has no motion pixel, thereby removing false color noise.

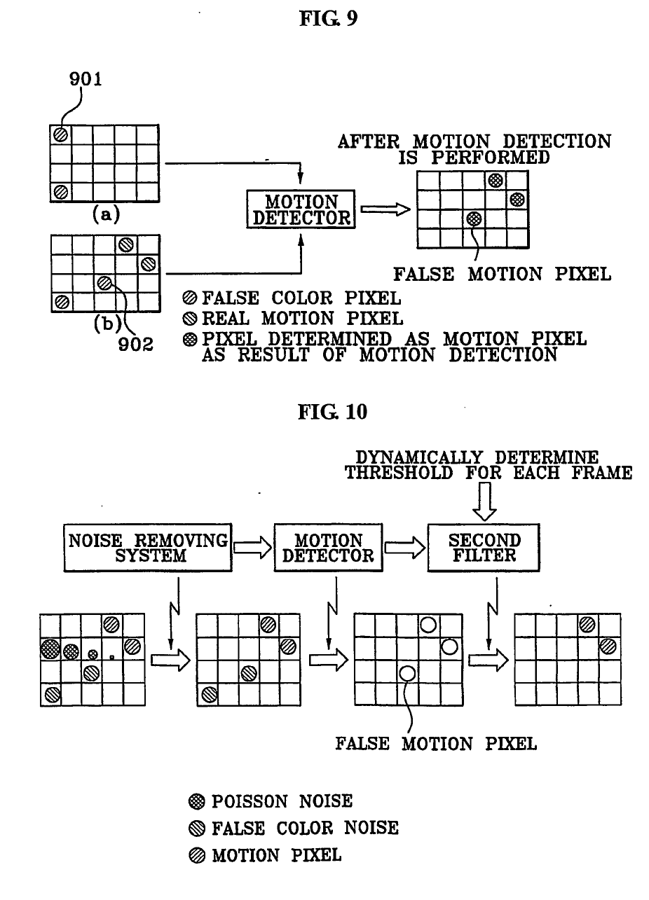

However, as illustrated in FIG. 9, the motion detector 503 may miscalculate that a pixel containing false color noise is a motion pixel. In the present specification, a pixel having false color noise, but determined to be a motion pixel is a “false motion pixel”.

(a) and (b) of FIG. 9 indicate areas corresponding to each other on consecutive frames. The motion detector 503 recognizes (a) and (b) of FIG. 9 consecutively, and may miscalculate that pixels marked by drawing symbols 901 and 902 are motion pixels, although the pixels contain false color noise.

In an image formed of consecutive frames, a false color pixel (a false motion pixel) has to be separated from a true motion pixel and disregarded. In the case of using a low pass filter as a temporal filter like a conventional art, detailed information may not be expressed properly because the low pass filter is too smoothing. Also, the low pass filter does not distinguish a false motion pixel which is not determined correctly because of false color noise, from a normal motion pixel. Thus, the false motion pixel cannot be removed by the low pass filter.

The second filter 504 according to the present invention dynamically determines a threshold for each frame, as described later. Thus, the second filter 504 corrects a false color pixel containing a false motion pixel and preserves image features such as edge or detailed information in a dark region.

Hereinafter, how the second filter 504 removes false color noise will be described in detail. For easy understanding, image data corresponding to a predetermined frame is “first image data” and image data corresponding to a frame inputted right after the predetermined frame is “second image data”.

The second filter 504 converts the first image data into a gray scale, thereby generating first gray scale image data, and converts the second image data into a gray scale, thereby generating second gray scale image data.

The second filter 504 calculates the entire mean, which is the mean of each pixel value of the first gray scale image data. Also, the second filter 504 calculates the mean of the unit area, which is the mean of each pixel value belonging to the unit area among the first gray scale image data, for each unit area. The size of the unit area for removing false color noise may be set to be different from that of the unit area for removing impulsive noise or Poisson noise or from that of the unit area for the motion detection.

In the case the mean of the unit area exceeds the entire mean, the second filter 504 selects a pixel having a larger gray scale value between pixels corresponding to the first gray scale image data and the second gray scale image data, respectively, that is, between pixels having identical coordinates.

In the case the mean of the unit area is less than the entire mean, the second filter 504 selects a pixel having a smaller gray scale value between pixels corresponding to the first gray scale image data and the second gray scale image data, respectively, that is, between pixels having identical coordinates.

The second filter 504 replaces a corresponding pixel of the first image data, which is a pixel in the current frame, with the selected pixel.

The process as above may be expressed like equation 7 below:

$$y ( i , {\dot{h}}^{t} ) = \{ \begin{matrix}max [ x ( i , j , t ) , x ( i , j , t - 1 ) ] & \overline{*} ( / , / , \dot{*} ) > \overline{X} ( β , J , t ) \\ min [ x ( i , j , t ) , x ( i , j , t - 1 ) ] & \overline{χ} ( i , j , t ) \leq \overline{X} ( i , j , t )\end{matrix} \qquad [ Equation 7 ]$$

x(i, j, t) and y(i, j, t) indicate gray scale values of pixels having corresponding coordinates in first image data and second image data, respectively. At this time, x̅(Uj>i) is the mean of the unit area and x̅(i, J, O is the entire mean. The second filter 504 calculates the mean of the unit area and the entire mean for each frame and determines whether to select the larger value or the smaller value between x(i,j,f) and x(i,j,t−1). The configuration as above is expressed as “dynamically determine threshold for each frame”.

In the method as described above, the second filter 504 checks false color noise in step S608 and removes the same in step S609. Also, since the second filter 504 calculates the threshold for each frame, a false motion pixel which has not been detected in the conventional art can also be effectively detected and removed.

FIG. 10 is a view schematically illustrating a process of removing impulsive noise, Poisson noise, and false color noise from image data included in at least one segment that is separated as a low light region.

Referring to FIG. 10, impulsive noise and Poisson noise are removed by the noise-removing system, and a false motion pixel miscalculated as a motion pixel by a motion detector is removed by a second filter using a dynamic threshold. Also, the noise removing system and second filter according to the present embodiment are designed to remove noise while preserving edge and detailed information. Consequently, in the case of using the image processing system according to the present embodiment, a vivid image having without noise may be outputted from an image photographed in a low light environment.

FIG. 11 is a view comparing image processing results of a conventional art with results of image processing method and system according to the present invention. As described above, according to the present embodiment, the noise removing system (having a function of a spatial filter) is first applied to an image sent from a camera, and a motion is detected before a second filter (having a function of a temporal filter) is applied.

Referring to FIG. 11, noise is more effectively removed in image 1104 than image 1102 or 1103. Also, the image 1104 has clearer image features in the low light region than image 1102 or 1103. The image 1104 is a result image that is obtained by processing the image 1101 sent from a camera in processing order as above. The image 1102 is a result image that is obtained by applying a spatial-temporal filter and performing the motion detection according to a conventional art. The image 1103 is a result image that is obtained by applying the motion detection and the spatial-temporal filter according to another conventional art.

As described above, the present invention first applies the noise removing system having the function of a spatial filter to an image, and later applies the second filter having the function of a temporal filter to the image. This causes smearing for pixels adjacent to a pixel having false color noise not to affect the motion detection. The smearing may occur as a result of application of the second filter. Accordingly, the present invention enables a motion detector to check the motion detection more accurately. Consequently, good quality image can be outputted on the whole.

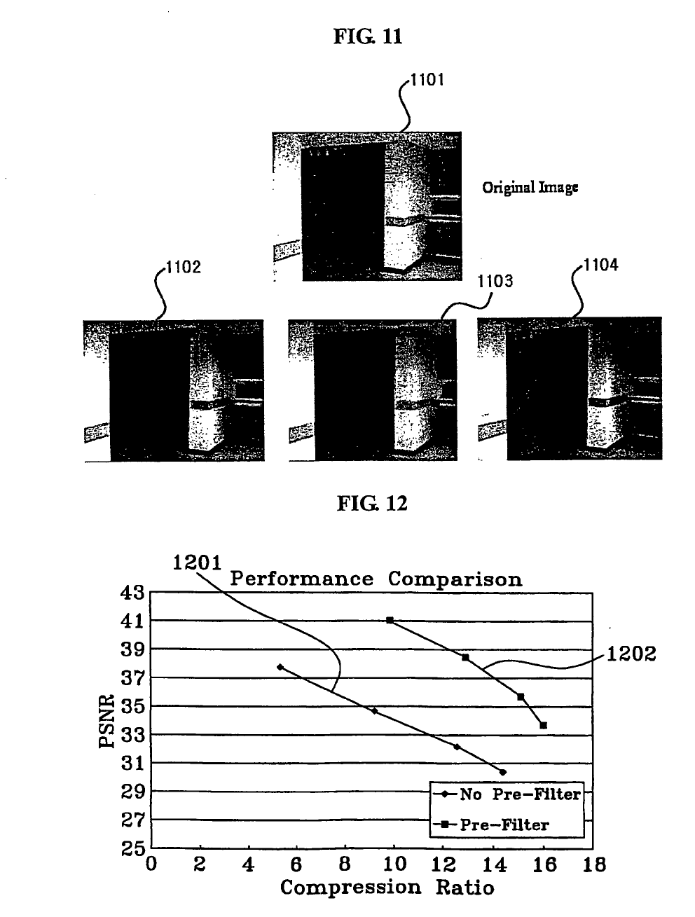

FIG. 12 is a view of the relationship between PSNR (Peak Signal to Noise Ratio) and compression ratio of a resulting image file processed with the image processing method and system according to an embodiment of the present invention compared with a resulting image file processed with a conventional art. The image processing system according to the present embodiment outputs a clear image having noise removed and detailed information preserved. Thus, even the compression effectiveness of the image by the video encoder 404 is improved.

Referring to FIG. 12, an image file processed by the image processing method and system according to an embodiment of the present invention 1202 has more effective performance than an image file processed in accordance with the conventional art 1201, with aspect to compression ratio and PSNR.

The embodiments of the present invention include computer readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

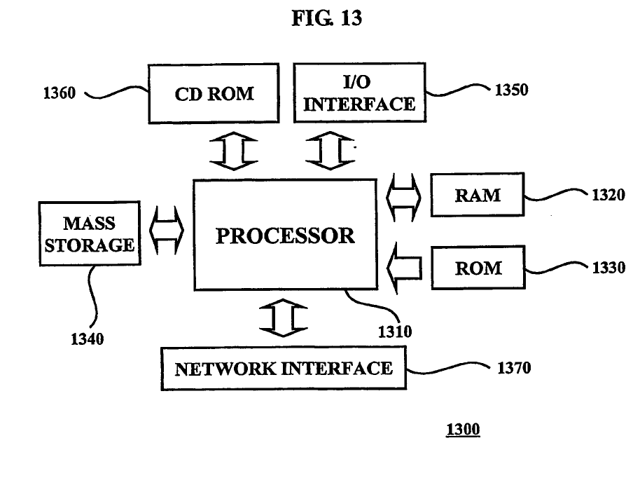

FIG. 13 is an internal block diagram of a general-purpose computer system which may be employed in implementing the image processing method and system according to the present invention.

The computer system 1300 includes any number of processors 1310 (also referred to as central processing units, or CPUs) that are coupled to storage devices including primary storage (typically a random access memory, or “RAM” 1320), primary storage (typically a read only memory, or “ROM” 1330). As is well known in the art, ROM 1330 acts to transfer data and instructions uni-directionally to the CPU and RAM 1320 is used typically to transfer data and instructions in a bi-directional manner. Both of these primary storage devices may include any suitable type of the computer-readable media described above. A mass storage device 1340 is also coupled bi-directionally to CPU and provides additional data storage capacity and may include any of the computer-readable media described above. The mass storage device 1340 may be used to store programs, data and the like and is typically a secondary storage medium such as a hard disk that is slower than primary storage. A specific mass storage device such as a CD-ROM 1360 may also pass data to the CPU. Processor 1310 is also coupled to an interface 1350 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1310 optionally may be coupled to a computer or telecommunications network using a network connection as shown generally at 1370. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of this invention.

### INDUSTRIAL APPLICABILITY

According to the present invention, there is provided a method for removing noise in an image, which can effectively remove impulsive noise or Poisson noise in the process of performing spatial filtering on the image and preserve the edge or detailed information of the image, thereby maintaining its resolution, and a system thereof.

Although the present invention has been described in connection with the embodiments of the present invention illustrated in the accompanying drawings, it is not limited thereto since it will be apparent to those skilled in the art that various substitutions, modifications and changes may be made thereto without departing from the scope and spirit of the invention.

Therefore, it is intended that the scope of the invention be defined by the claims appended thereto and their equivalents.

1. A method for removing noise in an image, the method comprising the steps of:
dividing image data contained in the image into predetermined unit areas;
calculating each threshold corresponding to the unit area by using values of pixels contained in the unit area;
detecting whether a first pixel containing impulsive noise exists in the unit area by using the calculated threshold;
applying a median filter to the first pixel in the case the first pixel is detected;
identifying a second pixel adjacent to the first pixel in the case the median filter is applied to the first pixel; and
applying a mean-variance filter to the second pixel.

2. The method of claim 1, wherein the step of calculating each threshold corresponding to the unit area by using values of pixels contained in the unit area comprises the step of calculating threshold=α+log₂(xₘ), and
said σ is the minimum threshold to detect a pixel containing impulsive noise and said xₘ is the mean of the values of the pixels contained in the unit area.

3. The method of claim 1, wherein a value of the second pixel which is filtered by applying the mean-variance filter to the second pixel is calculated as,
$$value of filtered second pixel = \frac{{σ}_{k}^{2} ( i , j ) k ( i , j ) + {\overline{k}}^{2} ( i , j )}{{σ}_{k}^{2} ( i , j ) + \overline{k} ( i , j )} ,$$
and
said 1σ(i, j) is a first pixel value in coordinates (i, j), said σk (i, j) is the variance of values of second pixels, and said k̅(i, j) is the mean of the values of the second pixels.

4. A computer readable record medium recording a program for implementing the method according to claim 1 in a computer.

5. A system for removing noise in an image, the system comprising:
a threshold calculation unit dividing image data contained in the image into predetermined unit areas and calculating each threshold corresponding to the unit area by using values of pixels contained in the unit area;
a first filter detecting whether a first pixel containing impulsive noise exists in the unit area by using the calculated threshold and applying a median filter to the first pixel in the case the first pixel is detected; and
a second filter identifying a second pixel adjacent to the first pixel and applying a mean-variance filter to the second pixel.
